(19) United States
(12) Patent Application Publication
(10) Pub. No.: US 2022/0391905 A1
(43) Pub. Date: Dec. 8, 2022

(54) Authentication of Users Using Historical Tipping Information to Generate Authentication Questions

(71) Applicant: Capital One Services, LLC, McLean, VA (US)

(72) Inventors: Joshua Edwards, Philadelphia, PA (US); Vyjayanthi Vadrevu, Pflugerville, TX (US); Daniel Miller, Astoria, NY (US); David Septimus, New York, NY (US); Tyler Maiman, Melville, NY (US)

(21) Appl. No.: 17/340,873

(22) Filed: Jun. 7, 2021

(51) Int. Cl. G06Q 20/40; G06Q 20/38; G06N 20/00

(52) U.S. Cl. CPC G06Q 20/4014; G06Q 20/4015; G06Q 20/389; G06Q 20/382; G06N 20/00

(57) ABSTRACT

Methods, systems, and apparatuses are described herein for improving computer authentication processes by generating authentication questions based on tipping trends. A computing device may receive a request for access to an account. Transactions data conducted by a user may be received. A tipping trend may be determined based on the one or more transactions conducted by the user. Based on the tipping trend, an authentication question may be generated. The authentication question may be provided, and a response to the authentication question may be received. A user device may be provided access to the account based on the response to the authentication question.

### FIELD OF USE

Aspects of the disclosure relate generally to account security. More specifically, aspects of the disclosure may provide for improvements in the method in which authentication questions are generated through the use of tipping trends analyzed based on transaction data.

### BACKGROUND

As part of determining whether to grant a user access to content (e.g., as part of determining whether to provide a caller access to a telephone system that provides banking information), a user of the user device might be prompted with one or more authentication questions. Such questions might relate to, for example, a password of the user, a personal identification number (PIN) of the user, or the like. Those questions might additionally and/or alternatively be generated based on personal information of the user. For example, when setting up an account, a user might provide a variety of answers to predetermined questions (e.g., “Where was your father born?,” “Who was your best friend in high school?”), and those questions might be presented to the user as part of an authentication process. As another example, a commercially-available database of personal information might be queried to determine personal information for a user (e.g., their birthdate, birth state, etc.), and that information might be used to generate an authentication question (e.g., “Where were you born, and in what year?”).

As part of authenticating a computing device, information about financial transactions conducted by a user of that computing device might be used to generate authentication questions as well. For example, a user might be asked questions about one or more transactions conducted by the user in the past (e.g., “Where did you get coffee yesterday?,” “How much did you spend on coffee yesterday?,” or the like). Such questions might prompt a user to provide a textual answer (e.g., by inputting an answer in a text field), to select one of a plurality of answers (e.g., select a single correct answer from a plurality of candidate answers), or the like. In some instances, the user might be asked about transactions that they did not conduct. For example, a computing device might generate a synthetic transaction (that is, a fake transaction that was never conducted by a user), and ask a user to confirm whether or not they conducted that transaction. Authentication questions can be significantly more useful when they can be based on either real transactions or synthetic transactions: after all, if every question related to a real transaction, a nefarious user could use personal knowledge of a legitimate user to guess the answer, and/or the nefarious user might be able to glean personal information about the legitimate user.

Generally, one goal of an authentication question is that it is easy for a legitimate user to answer, whereas it is difficult for an unauthorized (e.g., malicious) user to answer. That said, because users might commonly conduct similar transactions (e.g., spend the same amount for lunch on a workday, spend about the same amount at a local gas station, routinely pay the same online subscription services on a monthly basis), in some circumstances, simple transaction-based questions might be guessable by unauthorized users. For example, the question “Did you spend $5 for an online video service this month?” might be easily answered in the affirmative for most middle-class users, meaning that the question might inadvertently provide unauthorized users access to the account.

Aspects described herein may address these and other problems, and generally improve the safety of financial accounts and computer transaction systems by using tipping information to generate authentication questions that might be easily answered by a legitimate user, but which might be difficult for a malicious user to answer.

### SUMMARY

The following presents a simplified summary of various aspects described herein. This summary is not an extensive overview, and is not intended to identify key or critical elements or to delineate the scope of the claims. The following summary merely presents some concepts in a simplified form as an introductory prelude to the more detailed description provided below.

Aspects described herein may allow for improvements in the manner in which authentication questions are used to control access to accounts. The improvements described herein relate to the generation of authentication questions which relate to the tipping activity of users. Such tipping activity has numerous benefits as a source of data for authentication questions: it can be extrapolated to a tipping trend (e.g., a trend of tips made by the user at a certain category of restaurants), it can range widely based on the spending proclivities of a particular user (e.g., in that they might tip differently at different categories of merchant), and it is often not provided as a separate line-item on the general ledger of financial accounts (as, in many cases, it might be maintained internally by a financial institution as a difference between an authorized amount and a corresponding final transaction amount, and need not be surfaced to a user). In turn, even if a malicious user were to somehow acquire access to a general ledger of an account (e.g., by stealing a user's mail), the malicious user could not necessarily use this information to answer questions about the tipping habit of a user. As such, as will be described herein, a tipping trend might be identified based on an account's transactions data, and that tipping trend might be used to generate an authentication question that might test the user on their knowledge of their own tipping habits in a variety of circumstances (e.g., during a past transaction, at a particular location, when shopping at a particular merchant, or the like). This might serve to make authentication questions easier to answer for legitimate users and harder to answer for unauthorized users, significantly improving the protection of computer resources.

More particularly, some aspects described herein may provide for a computing device that may receive, from a user device, a request for access to an account associated with a user. The computing device may receive, from a transactions database, transactions data corresponding to the account. That transactions data may indicate one or more transactions conducted by the user. The computing device may determine, based on the one or more transactions conducted by the user, a tipping trend of the user. The computing device may generate, based on the tipping trend, an authentication question. The authentication question may relate to whether the user paid a tip having a value that is inconsistent with the tipping trend. The computing device may provide the authentication question to the user device. The computing device may receive, from the user device, a response to the authentication question. The computing device may then provide, based on the response to the authentication question, the user device access to the account.

According to some embodiments, the computing device may determine the tipping trend by training a machine learning model to identify tipping trends based on a history of tipping activity by a plurality of different users and providing, as input to the trained machine learning model, the transactions data; and receive, as output from the trained machine learning model, the tipping trend. The computing device may determine the tipping trend by determining an authorization amount for a particular transaction and comparing the authorization amount and a corresponding final transaction amount, corresponding to the particular transaction, indicated by the transactions data. The computing device may determine the tipping trend by receiving, via an e-mail database, e-mail account data associated with the user, and parsing the e-mail account data to identify one or more tips that correspond to the one or more transactions conducted by the user. The computing device may determine the tipping trend by determining, based on a first portion of the one or more transactions conducted by the user, a first tipping trend for a first category of merchant, and determining, based on a second portion of the one or more transactions conducted by the user, a second tipping trend for a second category of merchant. Then, the computing device may generate the authentication question by selecting a merchant category for the authentication question and selecting from the first tipping trend and the second tipping trend based on the merchant category. The computing device may generate the authentication question by selecting, from a merchants database, a merchant, generating, based on the merchant, a synthetic transaction that was not conducted by the user, and generating, based on the synthetic transaction, a synthetic authentication question. In that case, the synthetic transaction may comprise a tip that is inconsistent with the tipping trend. The computing device may determine the tipping trend by determining whether the user calculates tips based on one of: a pre-tax value or a post-tax value. The computing device may determine the tipping trend by determining, based on a first portion of the one or more transactions conducted by the user, a first tipping trend for a first category of geographical locations and determining, based on a second portion of the one or more transactions conducted by the user, a second tipping trend for a second category of geographical locations. In that case, the computing device may generate the authentication question by determining a first geographical location corresponding to the authentication question and selecting from the first tipping trend and the second tipping trend based on the first geographical location.

Corresponding method, apparatus, systems, and computer-readable media are also within the scope of the disclosure.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIG. 1 depicts an example of a computing device that may be used in implementing one or more aspects of the disclosure in accordance with one or more illustrative aspects discussed herein;

FIG. 2 depicts an example deep neural network architecture for a model according to one or more aspects of the disclosure;

FIG. 3 depicts a system comprising different computing devices that may be used in implementing one or more aspects of the disclosure in accordance with one or more illustrative aspects discussed herein;

FIG. 4 depicts a flow chart comprising steps which may be performed for generating an authentication question based on a tipping trend; and

FIG. 5 depicts examples of tipping data, a tipping trend, and an authentication question.

### DETAILED DESCRIPTION

In the following description of the various embodiments, reference is made to the accompanying drawings, which form a part hereof, and in which is shown by way of illustration various embodiments in which aspects of the disclosure may be practiced. It is to be understood that other embodiments may be utilized and structural and functional modifications may be made without departing from the scope of the present disclosure. Aspects of the disclosure are capable of other embodiments and of being practiced or being carried out in various ways. Also, it is to be understood that the phraseology and terminology used herein are for the purpose of description and should not be regarded as limiting. Rather, the phrases and terms used herein are to be given their broadest interpretation and meaning. The use of “including” and “comprising” and variations thereof is meant to encompass the items listed thereafter and equivalents thereof as well as additional items and equivalents thereof.

By way of introduction, aspects discussed herein may relate to methods and techniques for improving authentication questions used during an authentication process. In particular, the process depicted herein may analyze transaction information to determine tipping trends which can be used to generate authentication questions which might be easier for a legitimate user to answer, but which might be hard for an unauthorized user to guess.

As an example of one problem addressed by the current disclosure, an authentication system might, as part of an authentication process for accessing an account, generate an authentication question that asks a user whether they recently spent $10 at a coffee shop. An unauthorized user might be able to guess the answer to this question in a variety of ways. For example, the unauthorized user might know a legitimate user of the account, such that they might be able to guess whether, based on what they know about the legitimate user (e.g., their spending habits, job, location), the legitimate user would shop at that coffee shop (e.g., if they like coffee, if the shop is local, and the like). As another example, unauthorized user might have access to the general ledger of a legitimate user's financial account (e.g., by stealing their mail), such that they might know all of their recent transactions. In either example, a relatively strong-sounding authentication question might in fact be quite weak and guessable.

Aspects described herein improve the functioning of computers by improving the way in which computers provide authentication questions and protect computer-implemented accounts. The speed and processing complexity of computing devices allows them to present more complicated authentications than ever before, which advantageously can improve the security of sensitive account information. That said, the algorithms with which authentication questions are generated can have security holes, which might render those authentication questions undesirably vulnerable to exploitation. Such exploitation can result in the illegitimate use and abuse of computer resources. The processes described herein improve this process by using data that cannot be easily gleaned from account general ledgers (e.g., tipping data, which requires after-the-fact processing to determine and which is generally not provided in general ledgers of financial accounts), thereby improving the safety of authentication questions by generating authentication questions that cannot be easily answered by unauthorized users. Such steps cannot be performed by a user and/or via pen and paper at least because the problem is fundamentally rooted in computing processes, involves a significantly complex amount of data and word processing, and requires steps (e.g., authenticating computerized requests for access) which cannot be performed by a human being.

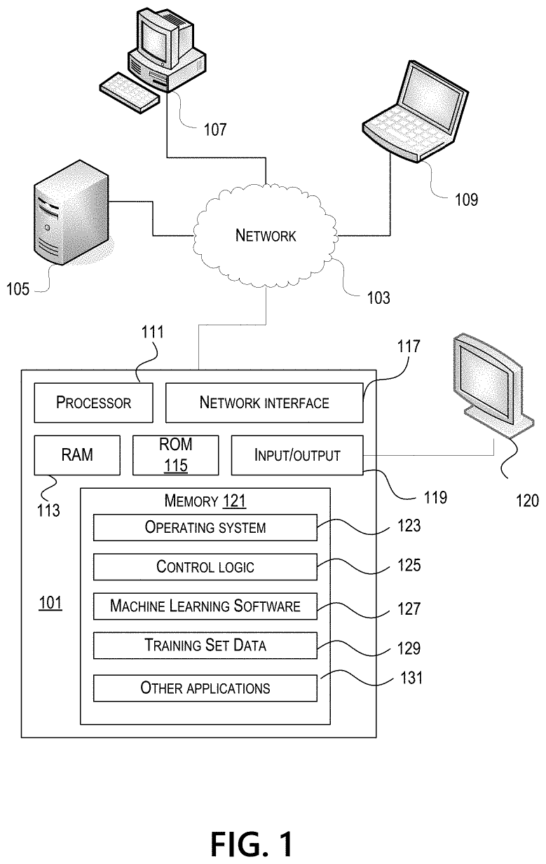

Before discussing these concepts in greater detail, however, several examples of a computing device that may be used in implementing and/or otherwise providing various aspects of the disclosure will first be discussed with respect to FIG. 1.

FIG. 1 illustrates one example of a computing device 101 that may be used to implement one or more illustrative aspects discussed herein. For example, computing device 101 may, in some embodiments, implement one or more aspects of the disclosure by reading and/or executing instructions and performing one or more actions based on the instructions. In some embodiments, computing device 101 may represent, be incorporated in, and/or include various devices such as a desktop computer, a computer server, a mobile device (e.g., a laptop computer, a tablet computer, a smart phone, any other types of mobile computing devices, and the like), and/or any other type of data processing device.

Computing device 101 may, in some embodiments, operate in a standalone environment. In others, computing device 101 may operate in a networked environment. As shown in FIG. 1, computing devices 101, 105, 107, and 109 may be interconnected via a network 103, such as the Internet. Other networks may also or alternatively be used, including private intranets, corporate networks, LANs, wireless networks, personal networks (PAN), and the like. Network 103 is for illustration purposes and may be replaced with fewer or additional computer networks. A local area network (LAN) may have one or more of any known LAN topology and may use one or more of a variety of different protocols, such as Ethernet. Devices 101, 105, 107, 109 and other devices (not shown) may be connected to one or more of the networks via twisted pair wires, coaxial cable, fiber optics, radio waves or other communication media.

As seen in FIG. 1, computing device 101 may include a processor 111, RAM 113, ROM 115, network interface 117, input/output interfaces 119 (e.g., keyboard, mouse, display, printer, etc.), and memory 121. Processor 111 may include one or more computer processing units (CPUs), graphical processing units (GPUs), and/or other processing units such as a processor adapted to perform computations associated with machine learning. I/O 119 may include a variety of interface units and drives for reading, writing, displaying, and/or printing data or files. I/O 119 may be coupled with a display such as display 120. Memory 121 may store software for configuring computing device 101 into a special purpose computing device in order to perform one or more of the various functions discussed herein. Memory 121 may store operating system software 123 for controlling overall operation of computing device 101, control logic 125 for instructing computing device 101 to perform aspects discussed herein, machine learning software 127, and training set data 129. Control logic 125 may be incorporated in and may be a part of machine learning software 127. In other embodiments, computing device 101 may include two or more of any and/or all of these components (e.g., two or more processors, two or more memories, etc.) and/or other components and/or subsystems not illustrated here.

Devices 105, 107, 109 may have similar or different architecture as described with respect to computing device 101. Those of skill in the art will appreciate that the functionality of computing device 101 (or device 105, 107, 109) as described herein may be spread across multiple data processing devices, for example, to distribute processing load across multiple computers, to segregate transactions based on geographic location, user access level, quality of service (QoS), etc. For example, computing devices 101, 105, 107, 109, and others may operate in concert to provide parallel computing features in support of the operation of control logic 125 and/or machine learning software 127.

One or more aspects discussed herein may be embodied in computer-usable or readable data and/or computer-executable instructions, such as in one or more program modules, executed by one or more computers or other devices as described herein. Generally, program modules include routines, programs, objects, components, data structures, etc. that perform particular tasks or implement particular abstract data types when executed by a processor in a computer or other device. The modules may be written in a source code programming language that is subsequently compiled for execution, or may be written in a scripting language such as (but not limited to) HTML or XML. The computer executable instructions may be stored on a computer readable medium such as a hard disk, optical disk, removable storage media, solid state memory, RAM, etc. As will be appreciated by one of skill in the art, the functionality of the program modules may be combined or distributed as desired in various embodiments. In addition, the functionality may be embodied in whole or in part in firmware or hardware equivalents such as integrated circuits, field programmable gate arrays (FPGA), and the like. Particular data structures may be used to more effectively implement one or more aspects discussed herein, and such data structures are contemplated within the scope of computer executable instructions and computer-usable data described herein. Various aspects discussed herein may be embodied as a method, a computing device, a data processing system, or a computer program product.

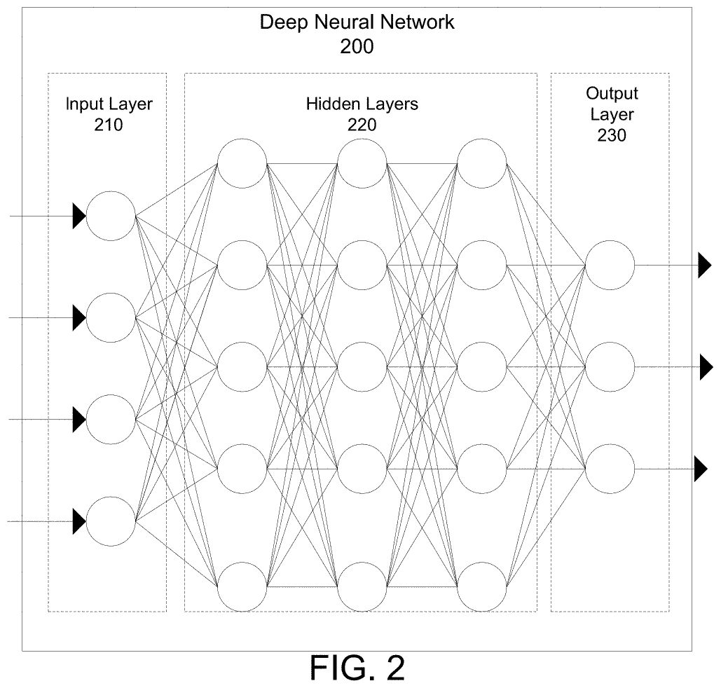

FIG. 2 illustrates an example deep neural network architecture 200. Such a deep neural network architecture might be all or portions of the machine learning software 127 shown in FIG. 1. That said, the architecture depicted in FIG. 2 need not be performed on a single computing device, and might be performed by, e.g., a plurality of computers (e.g., one or more of the devices 101, 105, 107, 109). An artificial neural network may be a collection of connected nodes, with the nodes and connections each having assigned weights used to generate predictions. Each node in the artificial neural network may receive input and generate an output signal. The output of a node in the artificial neural network may be a function of its inputs and the weights associated with the edges. Ultimately, the trained model may be provided with input beyond the training set and used to generate predictions regarding the likely results. Artificial neural networks may have many applications, including object classification, image recognition, speech recognition, natural language processing, text recognition, regression analysis, behavior modeling, and others.

An artificial neural network may have an input layer 210, one or more hidden layers 220, and an output layer 230. A deep neural network, as used herein, may be an artificial network that has more than one hidden layer. Illustrated network architecture 200 is depicted with three hidden layers, and thus may be considered a deep neural network. The number of hidden layers employed in deep neural network 200 may vary based on the particular application and/or problem domain. For example, a network model used for image recognition may have a different number of hidden layers than a network used for speech recognition. Similarly, the number of input and/or output nodes may vary based on the application. Many types of deep neural networks are used in practice, such as convolutional neural networks, recurrent neural networks, feed forward neural networks, combinations thereof, and others.

During the model training process, the weights of each connection and/or node may be adjusted in a learning process as the model adapts to generate more accurate predictions on a training set. The weights assigned to each connection and/or node may be referred to as the model parameters. The model may be initialized with a random or white noise set of initial model parameters. The model parameters may then be iteratively adjusted using, for example, stochastic gradient descent algorithms that seek to minimize errors in the model.

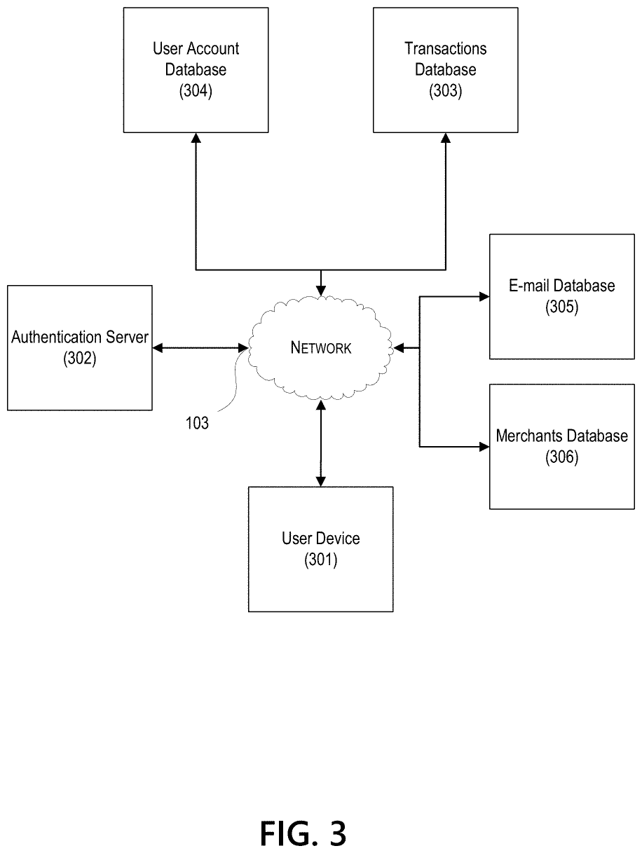

FIG. 3 depicts a system for authenticating a user device 301. The user device 301 is shown as connected, via the network 103, to an authentication server 302, a transactions database 303, a user account database 304, an e-mail database 305, and a merchants database 306. The network 103 may be the same or similar as the network 103 of FIG. 1. Each of the user device 301, the authentication server 302, the transactions database 303, the user account database 304, the e-mail database 305, and/or the merchants database 306 may be one or more computing devices, such as a computing device comprising one or more processors and memory storing instructions that, when executed by the one or more processors, perform one or more steps as described further herein. For example, any of those devices might be the same or similar as the computing devices 101, 105, 107, and 109 of FIG. 1.

As part of an authentication process, the user device 301 might communicate, via the network 103, to access the authentication server 302 to request access (e.g., to a user account). The user device 301 shown here might be a smartphone, laptop, or the like, and the nature of the communications between the two might be via the Internet, a phone call, or the like. For example, the user device 301 might access a website associated with the authentication server 302, and the user device 301 might provide (e.g., over the Internet and by filling out an online form) candidate authentication credentials to that website. The authentication server 302 may then determine whether the authentication credentials are valid. For example, the authentication server 302 might compare the candidate authentication credentials received from the user device 301 with authentication credentials stored by the user account database 304. In the case where the communication is telephonic, the user device 301 need not be a computing device, but might be, e.g., a conventional telephone.

The user account database 304 may store information about one or more user accounts, such as a username, password, demographic data about a user of the account, or the like. For example, as part of creating an account, a user might provide a username, a password, and/or one or more answers to predetermined authentication questions (e.g., “What is the name of your childhood dog?”), and this information might be stored by the user account database 304. The authentication server 302 might use this data to generate authentication questions. The user account database 304 might store demographic data about a user, such as their age, gender, location, occupation, education level, income level, and/or the like.

The transactions database 303 might comprise data relating to one or more transactions conducted by one or more financial accounts associated with a first organization. For example, the transactions database 303 might maintain all or portions of a general ledger for various financial accounts associated with one or more users at a particular financial institution. The data stored by the transactions database 303 may indicate one or more merchants (e.g., where funds were spent), an amount spent (e.g., in one or more currencies), a date and/or time (e.g., when funds were spent), or the like. The data stored by the transactions database 303 might be generated based on one or more transactions conducted by one or more users. For example, a new transaction entry might be stored in the transactions database 303 based on a user purchasing an item at a store online and/or in a physical store. As another example, a new transaction entry might be stored in the transactions database 303 based on a recurring charge (e.g., a subscription fee) being charged to a financial account. As will be described further below, synthetic transactions might be based, in whole or in part, on legitimate transactions reflected in data stored by the transactions database 303. In this way, the synthetic transactions might better emulate real transactions.

The data stored in the transactions database 303 might pertain to financial transactions involving a tip. A tip might comprise any gratuity or similar payment provided in addition to a value of a transaction. For example, a user might calculate a tip as a percentage of a pre-tax value and/or a post-tax value of a transaction, then pay that tip in addition to the pre-tax value and/or post-tax value in appreciation for good service. The data stored by the transactions database 303 might indicate such tipping information in a variety of ways. As part of a payment process, a payment system might first confirm, with a payment processor, an authorization amount. This authorization amount might be part of the data stored by the transactions database 303 and might correspond to, e.g., a post-tax value of the transaction. In this manner, the authorization amount might indicate an initial amount which a user is attempting to spend for goods and/or services. The payment system might then receive and store (e.g., in the transactions database 303) a corresponding final transaction amount. The corresponding final transaction amount might be a value equal to or greater than the authorization amount. Where the corresponding final transaction amount is greater than the authorization amount, this may indicate the existence of a tip.

As an example of how tip data might be reflected in transactions data stored by the transactions database 303, a user might buy a drink at a coffee shop which costs $5, including tax. This $5 value might be the authorization amount, as a point of sale system might provide this authorization amount to a payment processing service. Then, the user might tip $2. Accordingly, the corresponding final transaction amount might be $7, reflecting the $2 tip. While the general ledger available to a user might indicate that the transaction cost $7 (and thereby might not indicate how much the user tipped), the authorization amount and the corresponding final transaction amount might be stored by the transactions database 303. As such, while a user might not be able to determine that the tip amount was $2, the authorization server 302 (and/or another computing device) might be able to determine this amount by, e.g., subtracting the authorization amount ($5) from the corresponding final transaction amount ($7) to determine a tip ($2).

The account data stored by the user account database 304 and the transactions database 303 may, but need not be related. For example, the account data stored by the user account database 304 might correspond to a user account for a bank website, whereas the financial account data stored by the transactions database 303 might be for a variety of financial accounts (e.g., credit cards, checking accounts, savings accounts) managed by the bank. As such, a single user account might provide access to one or more different financial accounts, and the accounts need not be the same. For example, a user account might be identified by a username and/or password combination, whereas a financial account might be identified using a unique number or series of characters.

The e-mail database 305 may be a database which stores e-mail information for one or more users. The e-mails stored in the e-mail database 305 might be associated with an entirely different account as compared to the data stored by the user account database 304 and/or the transactions database 303. For example, the e-mail database might be an e-mail server managed by a third-party e-mail service provider. E-mails stored by the e-mail database 305 might be, for example, provided to the authentication server 302 based on receipt of user permission to access those e-mails. As will be detailed below, such e-mails might be used to identify tipping information above and beyond that provided by the transactions database 303.

The merchants database 306 may be a database which stores data about one or more merchants. For example, the merchants database 306 might comprise a list of one or more merchants, such as the name and/or locations of one or more restaurants, car dealerships, bars, clothing stores, and the like. Each of the merchants in the merchants database 306 might correspond to one or more merchant categories. For example, a restaurant might be associated with a “bar” merchant category as well as a “food” merchant category. As another example, a clothing store might be associated with a “clothing” merchant category. Such categories might be reflected in the data stored by the merchants database 306. For example, the merchants database 306 might store a Merchant Category Code (MCC) for each of a plurality of merchants. As will be described below, users might tip differently based on a merchant category (e.g., might tip differently at a restaurant as compared to a hairdresser), and this distinction might be used to generate authentication questions.

Having discussed several examples of computing devices which may be used to implement some aspects as discussed further below, discussion will now turn to a method for generating authentication questions based on tipping trends in a manner which improves the security of those authentication questions.

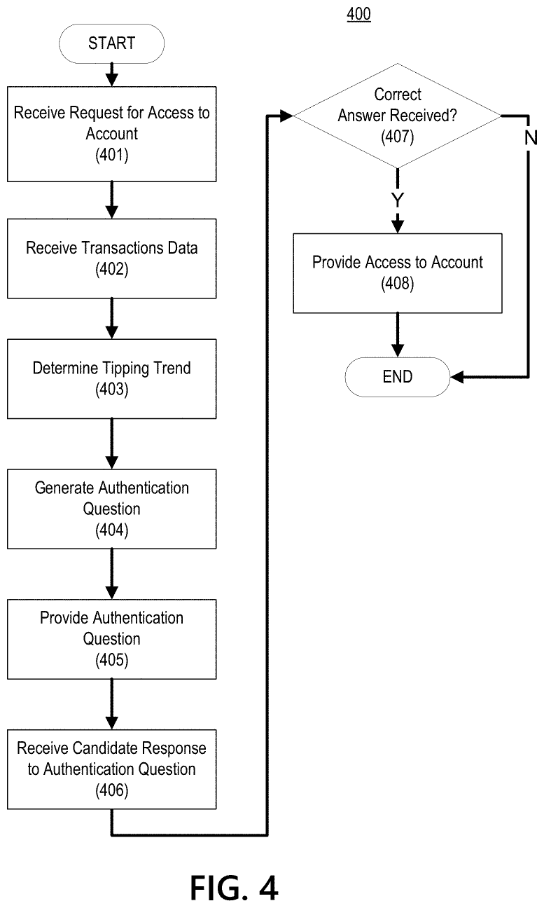

FIG. 4 illustrates an example method 400 for analyzing tipping data and presenting authentication questions in accordance with one or more aspects described herein. The method 400 may be implemented by a suitable computing system, as described further herein. For example, the method 400 may be implemented by any suitable computing environment by a computing device and/or combination of computing devices, such as one or more of the computing devices 101, 105, 107, and 109 of FIG. 1, and/or any computing device comprising one or more processors and memory storing instructions that, when executed by the one or more processors, cause the performance of one or more of the steps of FIG. 4. The method 400 may be implemented in suitable program instructions, such as in machine learning software 127, and may operate on a suitable training set, such as training set data 129. The method 400 may be implemented by computer-readable media that stores instructions that, when executed, cause performance of all or portions of the method 400. The steps shown in the method 400 are illustrative, and may be re-arranged or otherwise modified as desired.

In step 401, the computing device may receive a request for access to an account. For instance, the computing device may receive, from a user device, a request for access to an account associated with a user. The request may be associated with access, by a user, to a website, an application, or the like. The request may additionally and/or alternatively be associated with, for example, a user device calling into an IVR system or similar telephone response system. For example, the computing device may receive an indication of a request for access to an account responsive to a user accessing a log-in page, calling a specific telephone number, or the like. The request may specifically identify an account via, for example, an account number, a username, or the like. For example, a user might call an IVR system and be identified (e.g., using caller ID) by their telephone number, which might be used to query the user account database 304 for a corresponding account.

In step 402, the computing device may receive transactions data. The transaction data may be received from, e.g., the transactions database 303. The transaction data might correspond to the account referenced in step 401. For example, the computing device may receive, from a transactions database, transactions data corresponding to the account. That transactions data may indicate one or more transactions conducted by the user. For example, the transactions data may comprise indications of purchases of goods and/or services made by a user. The transactions data might correspond to a period of time, such as a recent period of time (e.g., the last two months, the last four months, or the like). The transactions data might comprise indications, for one or more transactions, of an authorization amount and a corresponding final transaction amount. For example, a transaction conducted at a restaurant (e.g., payment for dinner) might correspond to two amounts: an authorization amount of $50, and a corresponding final transaction amount of $75. In that example, it might be inferred that a tip of $25 was provided: whereas the $50 amount might correspond to payment for the food (including tax), the $75 amount might correspond to payment for the food (including tax) and a tip.

In step 403, the computing device may determine a tipping trend. A tipping trend may be any data which represents a pattern of tips made by one or more users associated with an account. The tipping trend might be based on the transactions data. For example, the computing device may determine, based on the one or more transactions conducted by the user, a tipping trend of the user. To determine such a tipping trend, one or more tips might be determined for one or more transactions of a plurality of different transactions associated with an account. Then, a trend of the one or more tips (e.g., an average percentage value of a final amount tipped by the user) might be calculated by comparing the tips to a base value, such as a pre-tax or post-tax value of a corresponding transaction. In this way, it might be determined that, for example, a user of an account typically tips 15% of a post-tax value. As will be described below, the tipping trend might be based on a variety of different circumstances. For example, a particular user of an account might tip 15% at restaurants, but 10% at bars. As another example, a particular user of an account might tip 20% in the United States, but 10% abroad.

A tipping trend might be specific to a user of an account. An account might have a plurality of authorized users, and the tipping trend might be different based on the user of the account. For example, one authorized user might regularly tip 10% using a credit card, whereas another authorized user might regularly tip 15% using the same credit card or financial account. As such, as part of determining the tipping trend, an identity of a user (e.g., a user associated with the request received in step 401) might be identified.

Determining the tipping trend may comprise use of a machine learning model. As part of determining the tipping trend, a computing device may train a machine learning model (e.g., as implemented via the machine learning software 127 and/or the deep neural network 200) to identify tipping trends based on a history of tipping activity by a plurality of different users. For example, a machine learning model may be trained using training data that comprises a history of tipping activity by a plurality of different users, with indications of where the transactions were conducted (e.g., the identity of a merchant, the category of a merchant), how much of a tip was provided (e.g., $5 on a $10 bill, 10%, etc.), demographic data about the user(s) (e.g., a 45-year-old woman in Chicago, a 10-year-old child in Detroit), and the like. In this manner, the machine learning model may learn how to identify particular tipping trends for different types of users. For instance, the trained machine learning model might learn, based on the training data, that men in New York City dining at particular restaurants typically tip 15% when doing so, whereas women in New York City dining at different restaurants typically tip 18% when doing so. The computing device may then provide, as input to the trained machine learning model, the transactions data. In this manner, the computing device may prompt the trained machine learning model to process the transactions data to identify a tipping trend. The computing device may then receive, as output from the trained machine learning model, the tipping trend. For example, the output might indicate that, because the transactions data suggests that an account is similar to other accounts (e.g., in the training data), that a user of the account is likely to tip 10% at hairdressers, 20% at restaurants, and 15% at a valet. In this manner, the trained machine learning model might provide output indicating a predicted tipping trend, even where the transaction data might not necessarily comprise a sufficient amount of data to identify a tipping trend.

Determining the tipping trend may comprise analyzing e-mail account data. In some instances, the transaction data alone might be insufficient to determine a tipping trend. For example, the transaction data might lack the fidelity required to calculate tips for one or more transactions. Additionally and/or alternatively, users might tip using different accounts and/or cash, meaning that the transaction data (which, e.g., might reflect only certain credit card transactions) might not reflect such tips. Such tipping information might instead be reflected in e-mail data stored by, e.g., the e-mail database 305. A computing device may receive, via an e-mail database (e.g., the e-mail database 305), e-mail account data associated with the user. Those e-mails might be one or more e-mails stored by the e-mails database 305, and need not be all e-mails stored by the database. For example, the computing device might receive, from the e-mail database 305, e-mails specifically relating to financial transactions, comprising data suggestive of financial transactions (e.g., dollar signs), or the like. The computing device may then parse the e-mail account data to identify one or more tips that correspond to the one or more transactions conducted by the user. For example, the computing device may use one or more natural language processing techniques (e.g., one or more natural language processing algorithms) to analyze the e-mails and identify instances of tipping behavior, such as tipping amounts (e.g., as a dollar value, percentage value, or the like).

As part of analyzing the e-mail account data, e-mail templates might be used. Receipts might follow a standard format under certain circumstances. For example, some payment companies (e.g., PayPal Holdings, Inc. of San Jose, Calif.) provide receipts for transactions in a standardized format, such that a final transaction amount might nearly always be found in a first portion of the e-mail, the merchant name might always be found in a second portion of the format, a tip amount (if any) might nearly always be found in a third portion of the e-mail, and the like. Under certain circumstances, a template might be maintained such that this type of information might be regularly identified. For example, a template might specify certain Hypertext Markup Language (HTML) elements which regularly correspond to merchant names, payment amounts, etc. Accordingly, such templates might be used to process and identify data in e-mails in, e.g., the e-mail database 305.

Determining the tipping trend may comprise analyzing an authorization amount and a corresponding financial transaction amount for a transaction. As indicated above, one or more financial transactions (e.g., as reflected by data stored by the transactions database 303) might be associated with an authorization amount (e.g., an amount initially authorized on a credit card) and a corresponding final transaction amount (e.g., the amount actually billed to the credit card once a tip is accounted for). As such, a tip might be determined by comparing an authorization amount with a corresponding final transaction amount. As such, the computing device may determine an authorization amount for a particular transaction, then compare the authorization amount and a corresponding final transaction amount, corresponding to the particular transaction, indicated by the transactions data. For example, the computing device may subtract the authorization amount from the corresponding final transaction amount to determine a tip for a particular transaction. This process might be repeated for each transaction that comprises data indicating an authorization amount and a corresponding final transaction amount.

Determining the tipping trend may be based on whether a user calculates tips based on a certain base value, such as one or more of a pre-tax value or a post-tax value. Some users might tip based on different transaction values. For example, a first user of an account might tip 20% of a pre-tax value, whereas a second user of the account might tip 15% of a post-tax value. As part of determining the tipping trend, the computing device might determine the base value upon which a user of an account calculates the tip.

As part of determining how much a user tipped, taxes corresponding to a transaction might be determined. A database may be maintained that indicates taxes for different types of merchant in a variety of different geographical locations. The data from that database might be used to determine how much tax was paid as part of a transaction. That tax amount might be compared to a authorization amount and/or the a corresponding financial transaction amount to determine an amount that a user tipped. For example, an authorization amount for a bar purchase in a specific locality might be $10. The corresponding final transaction amount for the purchase might be $20. The aforementioned database might indicate that taxes for that transaction (e.g., for that particular merchant category and/or in that specific geographical region) are 20%. In that example, the post-tax cost of the transaction might be $12 and, subtracting that post-tax cost ($12) from the corresponding financial transaction amount ($20) suggests that a tip of $8 was paid. This calculation might be different if, for example, taxes also apply to the tipped amount. For example, in that circumstance, as the corresponding final transaction amount is $20, the taxes might be presumed to be approximately $3.34 and the tip might be presumed to be approximately $6.67.

Determining the tipping trend may comprise determining tipping trends for different geographical locations. Users of an account might tip differently in different geographical locations. For instance, a user might tip more at home than they do abroad, or vice versa. As such, part of determining the tipping trend might comprise determining how a user tips in different geographical locations. For example, a computing device may determine, based on a first portion of the one or more transactions conducted by the user, a first tipping trend for a first category of geographical locations and determine, based on a second portion of the one or more transactions conducted by the user, a second tipping trend for a second category of geographical locations. Such determinations might be made by, for example, processing transactions data to determine tips for a variety of different transactions, then determining geographical locations associated with that variety of different transactions (e.g., by determining a location of merchants where those transactions were conducted). In this manner, the computing device might determine, e.g., that a user of an account typically tips more in a first city than they tip in a second city. As will also be detailed below, the computing device may then generate an authentication question by selecting one of the geographical locations and selecting from the first tipping trend and the second tipping trend based on the geographical location.

Determining the tipping trend may comprise determining tipping trends for different categories of merchant. Users of an account might tip differently at different categories of merchant. For example, a user of an account might tip differently at a bar than they do a restaurant. As such, part of determining the tipping trend might comprise determining how a user tips at merchants of different merchant categories. For example, a computing device may determine, based on a first portion of the one or more transactions conducted by the user, a first tipping trend for a first category of merchant and determine, based on a second portion of the one or more transactions conducted by the user, a second tipping trend for a second category of merchant. Such determinations might be made by comparing tipping data, reflected by the transactions data (e.g., as stored in the transactions database 303), with merchant categories corresponding to merchants where those tips were paid. In this manner, the computing device might learn, e.g., that a user regularly tips 10% at hairdressers, 15% at bars, and 20% at restaurants. As will also be detailed below, the computing device may then generate an authentication question by selecting one of the merchant categories and selecting from the first tipping trend and the second tipping trend based on the merchant category.

In step 404, the computing device may generate an authentication question. An authentication question might be generated with a prompt (e.g., “How much did you tip at a coffee shop yesterday?”) as well as one or more correct answers (e.g., “$5,” “10%”) and one or more incorrect answers (e.g., “$10,” “20%”). Generating the authentication question may be based on the tipping trend. For example, the computing device may generate, based on the tipping trend, an authentication question. The authentication question may relate to whether a user paid a tip having a value that is inconsistent with the tipping trend determined in step 403. For example, if the tipping trend indicates that a user always tips 20%, the question might be “Did you tip $3 on a $10 yesterday?.” The authentication question may additionally and/or alternatively ask a user to pick a tip out of a plurality of tip options. For example, if the tipping trend determined in step 403 indicates that a user always tips 15%, the authentication question might ask “How much would you tip for dinner?,” with options including 13%, 15%, and 17%. In that example, the correct answer might be 15%, whereas other options might be incorrect. It may be desirable for the generated authentication question to vary in format, as this may prevent malicious users from guessing the answers to these questions.

The authentication question may be based on a tipping trend for a particular merchant category. As discussed above, users might tip differently at different categories of merchant. As such, the authentication question might ask a user to pick a normal tip for a particular merchant category. For example, if the tipping trend indicates that a user always tips 10% at a hairdresser, the authentication question might ask “How much would you tip at a hairdresser?,” with options including 10%, 20%, and 30%. In that example, the correct answer might be 10%, whereas other options might be incorrect. As another example, the authentication question might be “Where do you normally tip 10%,” with options including “Restaurants,” “New York City,” “Hairdressers,” and the like.

The authentication question may be based on a tipping trend for a particular geographical location. As discussed above, users might tip differently in different locations. As such, the authentication question might ask a user to pick a normal tip for a geographic location. For example, if the tipping trend indicates that a user always tips 12% when in Europe, the authentication question might ask “How much would you tip in Europe?,” with options including 12%, 24%, and 36%. In that example, the correct answer might be 12%, whereas other options might be incorrect. As another example, the authentication question might be “Where do you normally tip 12%,” with options including “The United States,” “Bars,” “Europe,” and the like.

Generating the authentication question may comprise use of a synthetic transaction. For example, a computing device may select, from a merchants database (e.g., the merchants database 306), a merchant. The merchant might be selected based on a location associated with the account, such that the merchant is a local merchant. Additionally and/or alternatively, the merchant might be selected based on demographics of a user of the account as reflected by, e.g., data stored by the user account database 304. The computing device may then generate, based on the merchant, a synthetic transaction that was not conducted by the user. For example, the computing device might randomly select Merchant A from the merchants database 306, then generate a synthetic transaction that (falsely) indicates that a user of an account spent $40 (and tipped $10) at Merchant A (a restaurant) on Wednesday night. In that circumstance, the synthetic transaction may comprise a tip that is inconsistent with the tipping trend. For instance, in the aforementioned example, the user might normally tip 10% at restaurants, but the synthetic transaction indicates a 25% tip at Merchant A (which is a restaurant). Then, the computing device may generate, based on the synthetic transaction, a synthetic authentication question. For example, the authentication question might ask: “Did you tip 25% at Merchant A on Wednesday?” and/or “Did you tip $10 on your $40 meal at Merchant A recently?”

In step 405, the computing device may provide the authentication question generated in step 404. For example, the computing device may provide the authentication question to the user device. Providing the authentication question may comprise causing one or more computing devices to display and/or otherwise output the authentication question. For example, the computing device may cause presentation, to the user, of the authentication question. The authentication question might be provided in a text format (e.g., in text on a website), in an audio format (e.g., over a telephone call), or the like.

In step 406, the computing device may receive a candidate response to the authentication question. For example, the computing device may receive, from the user device, a response to the authentication question. A candidate response may be any indication of a response, by a user, to the authentication question presented in step 405. For example, where an authentication question comprises one or more answers, the response might comprise a selection of at least one of the one or more answers. As another example, in the case of a telephone call, the candidate response might comprise an oral response to an authentication question provided using a text-to-speech system over the call.

In step 407, the computing device may determine whether the candidate response received in step 406 was correct. Determining whether the response is correct may comprise comparing the response to the correct answer determined as part of generating the authentication question in step 404. If the answer is correct, the method 400 may proceed to step 408. Otherwise, the flow chart may end.

In step 408, the computing device may provide access to the account. For example, the computing device may provide, based on the response to the authentication question, the user device access to the account. Access to the account might be provided by, e.g., providing a user device access to a protected portion of a website, transmitting confidential data to a user device, allowing a user to request, modify, and/or receive personal data (e.g., from the user account database 304 and/or the transactions database 303), or the like.

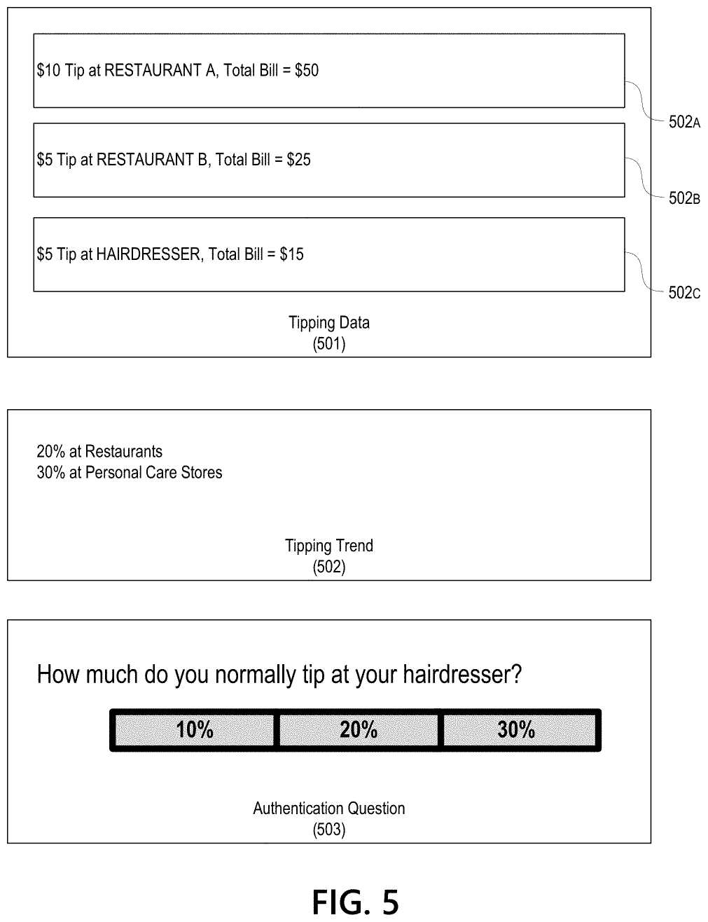

FIG. 5 depicts examples of tipping data 501, a tipping trend 502, and an authentication question 503. In this manner, FIG. 5 depicts illustrative data which might be part of all or portions of input and/or output of steps discussed with respect to FIG. 4, and which broadly illustrate how the tipping data 501 might be processed into the tipping trend 502 and ultimately used as part of the authentication question 503.

The tipping data 501 represents illustrative data which might be all or portions of the transactions data stored by the transactions database 303. The tipping data 501 illustrates three different transactions comprising tips by a user of an account, and which ultimately might be processed to identify a tipping trend (e.g., the tipping trend 502). A first transaction data element 502a indicates that a user of an account tipped $10 at “RESTAURANT A” on a total bill of $50. A second transaction data element 502b indicates that a user of the account tipped $5 at “RESTAURANT B” on a total bill of $25. A third transaction data element 502c indicates that a user of the account tipped $5 at “HAIRDRESSER” on a total bill of $15.

The tipping trend 502 might be all or portions of output from step 403 of FIG. 4, and might reflect processing of the tipping data 501. In particular, the tipping trend 502 indicates that a user typically tips 20% at restaurants (e.g., “RESTAURANT A,” “RESTAURANT B” from the tipping data 501) and 30% at personal care stores (e.g., “HAIRDRESSER” from the tipping data 501).

The authentication question 503 comprises an authentication question that may have been generated based on the tipping trend 502 and might be, e.g., all or portions of output as part of step 404 of FIG. 4. The authentication question 503 asks a user how much they usually tip at their hairdresser. The authentication question 503 provides three options: 10%, 20%, and 30%. In this case, given the tipping trend 502, the correct answer may be 30%, whereas the incorrect answers might be 10% and 20%.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computing device comprising:
one or more processors; and
memory storing instructions that, when executed by the one or more processors, cause the computing device to:
receive, from a user device, a request for access to an account associated with a user;
receive, from a transactions database, transactions data corresponding to the account, wherein the transactions data indicates one or more transactions conducted by the user;
determine, based on the one or more transactions conducted by the user, a tipping trend of the user;
generate, based on the tipping trend, an authentication question;
provide the authentication question to the user device;
receive, from the user device, a response to the authentication question; and
provide, based on the response to the authentication question, the user device access to the account.

2. The computing device of claim 1, wherein the instructions, when executed by the one or more processors, cause the computing device to determine the tipping trend by causing the computing device to:
train a machine learning model to identify tipping trends based on a history of tipping activity by a plurality of different users;
provide, as input to the trained machine learning model, the transactions data; and
receive, as output from the trained machine learning model, the tipping trend.

3. The computing device of claim 1, wherein the instructions, when executed by the one or more processors, cause the computing device to determine the tipping trend by causing the computing device to:
determine an authorization amount for a particular transaction; and
compare the authorization amount and a corresponding final transaction amount, corresponding to the particular transaction, indicated by the transactions data.

4. The computing device of claim 1, wherein the instructions, when executed by the one or more processors, cause the computing device to determine the tipping trend by causing the computing device to:
receive, via an e-mail database, e-mail account data associated with the user; and
parse the e-mail account data to identify one or more tips that correspond to the one or more transactions conducted by the user.

5. The computing device of claim 1, wherein the instructions, when executed by the one or more processors, cause the computing device to determine the tipping trend by causing the computing device to:
determine, based on a first portion of the one or more transactions conducted by the user, a first tipping trend for a first category of merchant; and
determine, based on a second portion of the one or more transactions conducted by the user, a second tipping trend for a second category of merchant; and
wherein the instructions, when executed by the one or more processors, cause the computing device to generate the authentication question by causing the computing device to:
select a merchant category for the authentication question; and
select from the first tipping trend and the second tipping trend based on the merchant category.

6. The computing device of claim 1, wherein the instructions, when executed by the one or more processors, cause the computing device to generate the authentication question by causing the computing device to:
select, from a merchants database, a merchant;
generate, based on the merchant, a synthetic transaction that was not conducted by the user, wherein the synthetic transaction comprises a tip that is inconsistent with the tipping trend; and
generate, based on the synthetic transaction, a synthetic authentication question.

7. The computing device of claim 1, wherein the instructions, when executed by the one or more processors, cause the computing device to determine the tipping trend by causing the computing device to:
determine whether the user calculates tips based on one of:
a pre-tax value; or
a post-tax value.

8. The computing device of claim 1, wherein the instructions, when executed by the one or more processors, cause the computing device to determine the tipping trend by causing the computing device to:
determine, based on a first portion of the one or more transactions conducted by the user, a first tipping trend for a first category of geographical locations; and
determine, based on a second portion of the one or more transactions conducted by the user, a second tipping trend for a second category of geographical locations; and
wherein the instructions, when executed by the one or more processors, cause the computing device to generate the authentication question by causing the computing device to:
determine a first geographical location corresponding to the authentication question; and
select from the first tipping trend and the second tipping trend based on the first geographical location.

9. The computing device of claim 1, wherein the authentication question relates to whether the user paid a tip having a value that is inconsistent with the tipping trend.

10. A method comprising:
receiving, by a computing device and from a user device, a request for access to an account associated with a user;
receiving, from a transactions database, transactions data corresponding to the account, wherein the transactions data indicates one or more transactions conducted by the user;
determining, based on the one or more transactions conducted by the user, a tipping trend of the user;
generating, based on the tipping trend, an authentication question;
providing the authentication question to the user device;
receiving, from the user device, a response to the authentication question; and
providing, based on the response to the authentication question, the user device access to the account.

11. The method of claim 10, wherein determining the tipping trend comprises:
training a machine learning model to identify tipping trends based on a history of tipping activity by a plurality of different users;
providing, as input to the trained machine learning model, the transactions data; and
receiving, as output from the trained machine learning model, the tipping trend.

12. The method of claim 10, wherein determining the tipping trend comprises:
determining an authorization amount for a particular transaction; and
comparing the authorization amount and a corresponding final transaction amount, corresponding to the particular transaction, indicated by the transactions data.

13. The method of claim 10, wherein determining the tipping trend comprises:
receiving, via an e-mail database, e-mail account data associated with the user; and
parsing the e-mail account data to identify one or more tips that correspond to the one or more transactions conducted by the user.

14. The method of claim 10, wherein determining the tipping trend comprises:
determining, based on a first portion of the one or more transactions conducted by the user, a first tipping trend for a first category of merchant; and
determining, based on a second portion of the one or more transactions conducted by the user, a second tipping trend for a second category of merchant; and
wherein generating the authentication question comprises:
selecting a merchant category for the authentication question; and
selecting from the first tipping trend and the second tipping trend based on the merchant category.

15. The method of claim 10, wherein generating the authentication question comprises:
selecting, from a merchants database, a merchant;
generating, based on the merchant, a synthetic transaction that was not conducted by the user, wherein the synthetic transaction comprises a tip that is inconsistent with the tipping trend; and
generating, based on the synthetic transaction, a synthetic authentication question.

16. One or more non-transitory computer-readable media storing instructions that, when executed by one or more processors, cause a computing device to:
receive, from a user device, a request for access to an account associated with a user;
receive, from a transactions database, transactions data corresponding to the account, wherein the transactions data indicates one or more transactions conducted by the user;
determine, based on the one or more transactions conducted by the user, a tipping trend of the user;
generate, based on the tipping trend, an authentication question;
provide the authentication question to the user device;
receive, from the user device, a response to the authentication question; and
provide, based on the response to the authentication question, the user device access to the account.

17. The computer-readable media of claim 16, wherein the instructions, when executed by the one or more processors, cause the computing device to determine the tipping trend by causing the computing device to:
train a machine learning model to identify tipping trends based on a history of tipping activity by a plurality of different users;
provide, as input to the trained machine learning model, the transactions data; and
receive, as output from the trained machine learning model, the tipping trend.

18. The computer-readable media of claim 16, wherein the instructions, when executed by the one or more processors, cause the computing device to determine the tipping trend by causing the computing device to:
determine an authorization amount for a particular transaction; and
compare the authorization amount and a corresponding final transaction amount, corresponding to the particular transaction, indicated by the transactions data.

19. The computer-readable media of claim 16, wherein the instructions, when executed by the one or more processors, cause the computing device to determine the tipping trend by causing the computing device to:
receive, via an e-mail database, e-mail account data associated with the user; and
parse the e-mail account data to identify one or more tips that correspond to the one or more transactions conducted by the user.

20. The computer-readable media of claim 16, wherein the instructions, when executed by the one or more processors, cause the computing device to determine the tipping trend by causing the computing device to:
determine, based on a first portion of the one or more transactions conducted by the user, a first tipping trend for a first category of merchant; and
determine, based on a second portion of the one or more transactions conducted by the user, a second tipping trend for a second category of merchant; and
wherein the instructions, when executed by the one or more processors, cause the computing device to generate the authentication question by causing the computing device to:
select a merchant category for the authentication question; and
select from the first tipping trend and the second tipping trend based on the merchant category.
